(19) United States
(12) Patent Application Publication
(10) Pub. No.: US 2025/0046276 A1
(43) Pub. Date: Feb. 6, 2025

(54) Bagpipe With Flame Emitting System

(71) Applicant: Ryan Randall, Saint Joseph, MO (US)

(72) Inventor: Ryan Randall, Saint Joseph, MO (US)

(21) Appl. No.: 18/230,004

(22) Filed: Aug. 3, 2023

(51) Int. Cl. G10D 7/063; F41H 9/02

(52) U.S. Cl. CPC G10D 7/063; F41H 9/02

(57) ABSTRACT

A bagpipe with flame emitting system for attaching to a bagpipe includes a bagpipe having a plurality of drones each terminating in an open cap. A flame emitting apparatus is attached to the bagpipe and emits flames from each end cap of each drone actuated.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to flame emitters and more particularly pertains to a new flame emitter for attaching to a bagpipe.

### (2) Description of Related Art Including Information Disclosed Under 37 CFR 1.97 and 1.98

The prior art relates to flame emitters and includes a variety of flame emitters emitting a flame from a nozzle. Known prior art lacks a flame emitter being attached to a bagpipe and emitting flames from a plurality of nozzles being attached to an end cap of each one of a plurality of drones of the bagpipe.

### BRIEF SUMMARY OF THE INVENTION

An embodiment of the disclosure meets the needs presented above by generally comprising a bagpipe having a plurality of drones each terminating in an open cap. A flame emitting apparatus is attached to the bagpipe and emits flames from each end cap of each drone actuated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a bagpipe with flame emitting system according to an embodiment of the disclosure.

FIG. 2 is a detail isometric view of an embodiment of the disclosure.

FIG. 3 is a block diagram view of an embodiment of the disclosure.

FIG. 4 is an in-use view of an embodiment of the disclosure.

FIG. 5 is a bottom isometric view of an embodiment of the disclosure.

### DETAILED DESCRIPTION OF THE INVENTION

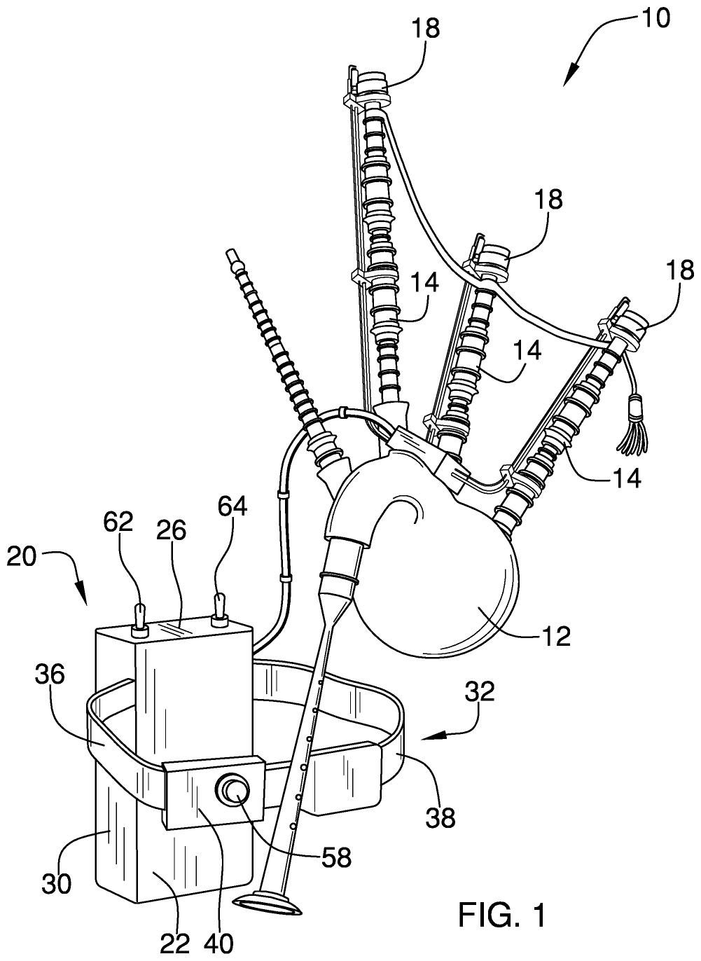

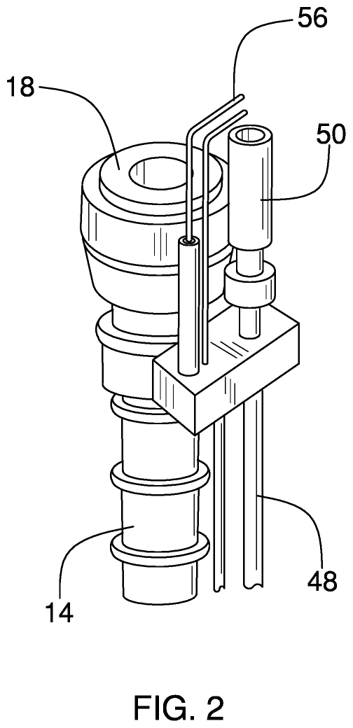

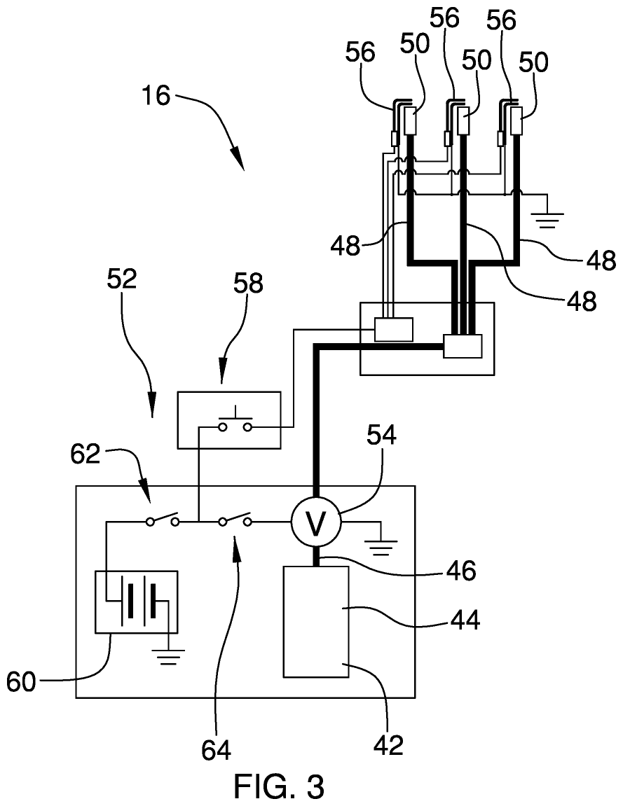

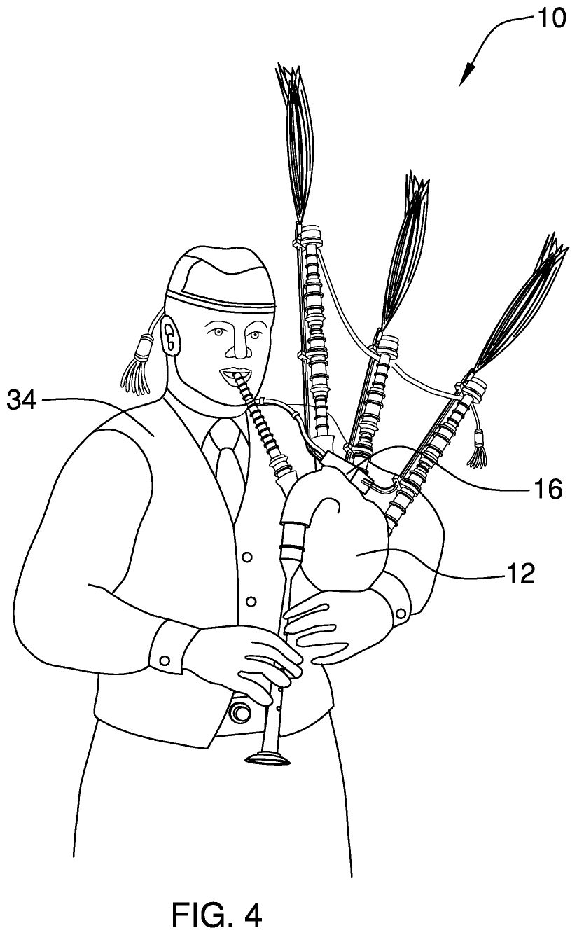

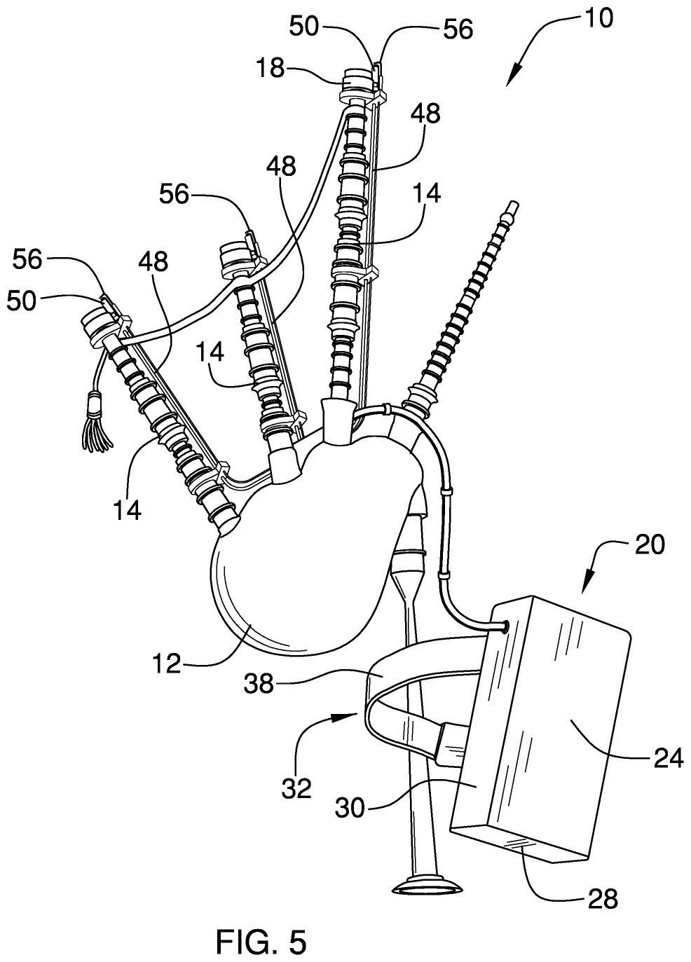

With reference now to the drawings, and in particular to FIGS. 1 through 5 thereof, a new flame emitter embodying the principles and concepts of an embodiment of the disclosure and generally designated by the reference numeral 10 will be described.

As best illustrated in FIGS. 1 through 5, the bagpipe with flame emitting system 10 generally comprises a bagpipe 12 having a plurality of drones 14 each terminating in an open cap. A flame emitting apparatus 16 is attached to the bagpipe 12 and emits flames from each end cap 18 of each drone 14 actuated. The flame emitting apparatus 16 includes a housing 20 having a front wall 22, a back wall 24, a top wall 26, a bottom wall 28, and a pair of side walls 30. A body fastener 32 is attached to the housing 20 to removably secure the housing 20 to the user 34 of the bagpipe 12. The body fastener 32 will typically comprise a belt having a first portion 36 and a second portion 38 coupled to and extending from each side wall 30. A buckle 40 removably secures the first 36 and second 38 portions to each other.

A tank 42 is positioned within the housing 20 and a quantity of propane gas 44 is positioned in the tank 42. An outlet 46 is in fluid communication with the tank 42 and a plurality of tubes 48 is in fluid communication with the outlet 46. Each of the tubes 48 has an outlet 50 positioned adjacent to a different one of the end caps 18 and is attached to an associated one of the drones 14. A gas release and igniting apparatus 52 is mounted in the housing 20 and on the drones 14. The gas release and igniting apparatus 52 releases propane gas 44 from the tank 42 and outwardly through the outlets 50 and ignites the propane gas 44 as the propane gas 44 leaves the outlets 50.

The gas release and igniting apparatus 52 typically includes a gas valve 54 in fluid communication with the outlet 46. The gas valve 54 is electrically actuatable between an open position and a closed position and the gas valve 54 is in a normally closed position. The gas valve 54 is positioned within the housing 20. A plurality of ignition heads 56 is positioned adjacent to each one of the outlets 50. An ignition switch 58 is positioned outside of the housing 20 and is electrically coupled to the gas valve 54 and the ignition heads 56 wherein the gas valve 54 is moved to an open position and the ignition heads 56 are electrified when the ignition switch 58 is actuated. The ignition switch 58 is typically positioned on the body fastener 32.

A power source 60 is electrically coupled to the ignition switch 58 to supply electrical power to the gas valve 54 and to the ignition heads 56. The power source 60 may comprise a battery mounted in the housing 20. A master switch 62 is positioned on the housing 20 and is in electrical communication with the ignition switch 58 and the power source 60. The master switch 62 is actuated to an off position to cut electrical power to the ignition switch 58 and to an on position to provide electrical power to the ignition switch 58. A gas flow switch 64 is positioned on the housing 20 and is in electrical communication with the gas valve 54 and the power source 60. The gas flow switch 64 is actuated to a first position to cut electrical power to the gas valve 54 and a second position to provide electrical power to the gas valve 54.

In use, the body fastener 32 is secured to the user 34 of the bagpipe 12. The master switch 62 is actuated to the on position and the gas flow switch 64 is actuated to the second position. The user 34 then can actuate the ignition switch 58 to emit flames from the end cap 18 of each of the drones 14 to enhance a visual appearance of the bagpipes 12 when in-use.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bagpipe with flame emitting system comprising:
a bagpipe having a plurality of drones each terminating in an open cap; and
a flame emitting apparatus being attached to said bagpipe and emitting flames from each end cap of each drone actuated.

2. The bagpipe with flame emitting system of claim 1, wherein said flame emitting apparatus includes a housing having a front wall, a back wall, a top wall, a bottom wall, and a pair of side walls.

3. The bagpipe with flame emitting system of claim 2, further including a body fastener being attached to said housing to removably secure said housing to the user of said bagpipe, said body fastener comprising a belt, said belt having a first portion and a second portion coupled to and extending from each side wall, a buckle removably securing said first and second portions to each other.

4. The bagpipe with flame emitting system of claim 3, further including a tank being positioned within said housing, a quantity of propane gas being positioned in said tank.

5. The bagpipe with flame emitting system of claim 4, further including an outlet being in fluid communication with said tank.

6. The bagpipe with flame emitting system of claim 5, further including a plurality of tubes being in fluid communication with said outlet, each of said tubes having an outlet positioned adjacent to a different one of said caps and being attached to an associated one of said drones.

7. The bagpipe with flame emitting system of claim 6, further including a gas release and igniting apparatus being mounted in said housing and on said drones, said gas release and igniting apparatus releasing propane from the tank and outwardly through said outlets and igniting the propane gas as the propane gas leaves the outlets.

8. The bagpipe with flame emitting system of claim 7, wherein said gas release and igniting apparatus includes a gas valve being in fluid communication with said outlet, said gas valve being electrically actuatable between an open position and a closed position, said gas valve being in a normally closed position, said gas valve being positioned within said housing.

9. The bagpipe with flame emitting system of claim 8, further including a plurality of ignition heads, each of said outlets having one of said ignition heads positioned adjacent thereto.

10. The bagpipe with flame emitting system of claim 9, further including an ignition switch being positioned outside of said housing and being electrically coupled to said gas valve and said ignition heads, wherein said gas valve is moved to an open position and said ignition heads are electrified when said ignition switch is actuated, said ignition switch being positioned on said body fastener.

11. The bagpipe with flame emitting system of claim 10, further including a power source being electrically coupled to said ignition switch to supply electrical power to said gas valve and to said ignition heads, said power source comprising a battery mounted in said housing.

12. The bagpipe with flame emitting system of claim 11, further including a master switch being positioned on said housing and being in electrical communication with said ignition switch and said power source, said master switch being actuated to an off position to cut electrical power to said ignition switch and to an on position to provide electrical power to said ignition switch.

13. The bagpipe with flame emitting system of claim 12, further including a gas flow switch being positioned on said housing and being in electrical communication with said gas valve and said power source, said gas flow switch being actuated to a first position to cut electrical power to said gas valve and a second position to provide electrical power to said gas valve.

14. A bagpipe with flame emitting system comprising:
a bagpipe having a plurality of drones each terminating in an open cap;
a flame emitting apparatus being attached to said bagpipe and emitting flames from each end cap of each drone actuated, said flame emitting apparatus including:
a housing having a front wall, a back wall, a top wall, a bottom wall, and a pair of side walls;
a body fastener being attached to said housing to removably secure said housing to the user of said bagpipe, said body fastener comprising a belt, said belt having a first portion and a second portion coupled to and extending from each side wall, a buckle removably securing said first and second portions to each other;
a tank being positioned within said housing, a quantity of propane gas being positioned in said tank;
an outlet being in fluid communication with said tank;
a plurality of tubes being in fluid communication with said outlet, each of said tubes having an outlet positioned adjacent to a different one of said caps and being attached to an associated one of said drones;
a gas release and igniting apparatus being mounted in said housing and on said drones, said gas release and igniting apparatus releasing propane from the tank and outwardly through said outlets and igniting the propane gas as the propane gas leaves the outlets, said gas release and igniting apparatus including:
a gas valve being in fluid communication with said outlet, said gas valve being electrically actuatable between an open position and a closed position, said gas valve being in a normally closed position, said gas valve being positioned within said housing;
a plurality of ignition heads, each of said outlets having one of said ignition heads positioned adjacent thereto;
an ignition switch being positioned outside of said housing and being electrically coupled to said gas valve and said ignition heads, wherein said gas valve is moved to an open position and said ignition heads are electrified when said ignition switch is actuated, said ignition switch being positioned on said body fastener;
a power source being electrically coupled to said ignition switch to supply electrical power to said gas valve and to said ignition heads, said power source comprising a battery mounted in said housing;
a master switch being positioned on said housing and being in electrical communication with said ignition switch and said power source, said master switch being actuated to an off position to cut electrical power to said ignition switch and to an on position to provide electrical power to said ignition switch; and
a gas flow switch being positioned on said housing and being in electrical communication with said gas valve and said power source, said gas flow switch being actuated to a first position to cut electrical power to said gas valve and a second position to provide electrical power to said gas valve.
